(19) United States
(12) Patent Application Publication
(10) Pub. No.: US 2026/0270941 A1
(43) Pub. Date: Sep. 10, 2026

(54) RANGING NARROWBAND CHANNEL SYNCHRONIZATION IN WIRELESS COMMUNICATIONS

(71) Applicant: MEDIATEK INC., Hsinchu City (TW)

(72) Inventors: Li-Hsiang SUN, San Jose, CA (US); Li MA, San Jose, CA (US); James Chih-Shi YEE, San Jose, CA (US)

(21) Appl. No.: 19/167,768

(22) PCT Filed: Nov. 6, 2024
(86) PCT No.: PCT/CN2024/130066

§ 371 Date: Sep. 22, 2025

Related U.S. Application Data
(60) Provisional application No. 63/598,164, filed on Nov. 13, 2023.

(51) Int. Cl. H04W 64/00; H04J 3/06; H04W 12/104

(52) U.S. Cl. CPC H04W 64/00; H04J 3/0661; H04W 12/104

(57) ABSTRACT

Techniques pertaining to ranging narrowband (NB) channel synchronization in wireless communications are described. An apparatus (e.g., an initiator) initiates a ranging session by: (1) transmitting a start-of-ranging (SOR) message and a Poll message; and (2) receiving a Response message from each of one or more responders. The SOR message provides either: (a) explicit NB ranging channel information; or (b) a range block index (RangingBlockIndex) to which a time offset field in the SOR message points.

### CROSS REFERENCE TO RELATED PATENT APPLICATION

The present disclosure is part of a non-provisional patent application claiming the priority benefit of U.S. Provisional Patent Application No. 63/598,164, filed 13 Nov. 2023, the content of which herein being incorporated by reference in its entirety.

### TECHNICAL FIELD

The present disclosure is generally related to wireless communications and, more particularly, to ranging narrowband (NB) channel synchronization in wireless communications.

### BACKGROUND

Unless otherwise indicated herein, approaches described in this section are not prior art to the claims listed below and are not admitted as prior art by inclusion in this section.

In wireless communications such as ultra-wide bandwidth (UWB) under the Institute of Electrical and Electronics Engineers (IEEE) 802.15.4ab specifications, an initiator is allowed to continue advertisement polling (ADV-POLL) after starting a ranging control phase with a device. The initiator may initiate a one-to-many ranging session with multiple responders joining the same round. After the initiator has confirmed receipt of a RESPONSE message from a responder during the control phase, and unless initialization of further devices is required, the initiator is to discontinue ranging initialization and cease the transmission of ADV-POLL messages. Under the current IEEE specification, a start-of-ranging (SOR) does not have an explicit channel assignment of an NB ranging channel to which initiator/responder should switch initially. Instead, it is based on the NB Channel Seed and block index 0 to derive the NB channel. Moreover, under the current specification, it is assumed that the first ranging block of any responder has a range block index set to zero (RangingBlockIndex=0) and that message protection is only performed on REPORT messages.

Currently, for one-to-many (O2M) Multi-Millisecond (MMS) ranging, the responder may join the ranging session at different times/blocks. The current assumption is that, after session initiation, the ranging block index starts from zero. This, however, tends to create certain issues. Firstly, for NB ranging control channel switching/hopping based on RangingBlockIndex, responders joining at different ranging blocks may hop to different channels at the same round because their block index starts at different times. Secondly, for time-efficient ultra-wideband (UWB) ranging with physical-layer (PHY) security/ranging integrity fragments (RIFs), in order for initiator-to-responder(s) RIFS to be received by multiple responders, their V value used to generate the common scrambled timestamp sequence (STS) from the initiator must be synchronized. However, if different ranging sessions start at different blocks, the V value would start incrementing at different times, resulting in different values at the same block/round at different responders.

Furthermore, for current one-to-one (O2O) narrowband assisted (NBA) MMS ranging, if the 1^{st} O2O Response message is not received by the initiator, the initiator, having sent a O2O Poll message but having not received a O2O Response message, does not know whether the O2O Response message is not sent (e.g., start-of-ranging (SOR) message in the initialization phase or the 1^{st} O2O POLL message in ranging phase is not received by the responder) or the O2O Response message is sent but not received by the initiator. The responder, if having received the O2O Poll and sent the O2O Response message, may proceed to generate RIFS from the V value based on the block index 0 and the slot index of the RIFS .. However, the initiator would determine this as ranging initialization failure since O2O Response message is not received. To reattempt the initialization and without another exchange of UWB session key, the block index/slot index would be re-initialized to 0 based on the current requirement. This would result in the same RIF which was generated by the responder in the last failed attempt, thus compromising ranging security. To avoid the problem, upper layer would be invoked for another UWB session key exchange. The medium access control (MAC) protocol itself should handle this over-the-air error scenario instead of relying on an upper layer to re-synchronize/re-generate an entire new key.

In view of the above-described issues, there is a need for a solution of ranging NB channel synchronization in wireless communications.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to provide schemes, concepts, designs, techniques, methods, and apparatuses pertaining to ranging NB channel synchronization in wireless communications. It is believed that various schemes proposed herein may address or otherwise alleviate these aforementioned issue(s).

In one aspect, a method may involve an initiator initiating or otherwise performing a ranging session by: (1) transmitting a start-of-ranging (SOR) message and a Poll message; and (2) receiving a Response message from each of one or more responders. The SOR message may provide either: (a) explicit NB ranging channel information; or (b) a range block index (RangingBlockIndex) to which a time offset field in the SOR message points.

In another aspect, a method may involve a responder participating in a ranging session by: (1) receiving a start-of-ranging (SOR) message and a Poll message from an initiator; and (2) transmitting a Response message responsive to the received Poll message. The SOR message may provide either: (a) explicit NB ranging channel information; or (b) a RangingBlockIndex to which a time offset field in the SOR message points.

It is noteworthy that, although the description provided herein may be in the context of certain radio access technologies, networks and network topologies such as, Wi-Fi, the proposed concepts, schemes and any variation(s)/derivative(s) thereof may be implemented in, for and by other types of radio access technologies, networks and network topologies such as, for example and without limitation, Bluetooth, ZigBee, 5^{th} Generation (5G)/New Radio (NR), Long-Term Evolution (LTE), LTE-Advanced, LTE-Advanced Pro, Internet-of-Things (IoT), Industrial IoT (IIoT) and narrowband IoT (NB-IoT). Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation to clearly illustrate the concept of the present disclosure.

FIG. 1 is a diagram of an example network environment in which various schemes in accordance with the present disclosure may be implemented.

FIG. 2 is a diagram of an example scenario in which various proposed schemes in accordance with the present disclosure may be implemented.

FIG. 3 is a diagram of an example scenario in which various proposed schemes in accordance with the present disclosure may be implemented.

FIG. 4 is a diagram of an example scenario in which various proposed schemes in accordance with the present disclosure may be implemented.

FIG. 5 is a block diagram of an example communication system in accordance with various implementations of the present disclosure.

FIG. 6 is a flowchart of an example process in accordance with various implementations of the present disclosure.

FIG. 7 is a flowchart of an example process in accordance with various implementations of the present disclosure.

### DETAILED DESCRIPTION

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that the description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to ranging NB channel synchronization in wireless communications. According to the present disclosure, a number of possible solutions may be implemented separately or jointly. That is, although these possible solutions may be described below separately, two or more of these possible solutions may be implemented in one combination or another.

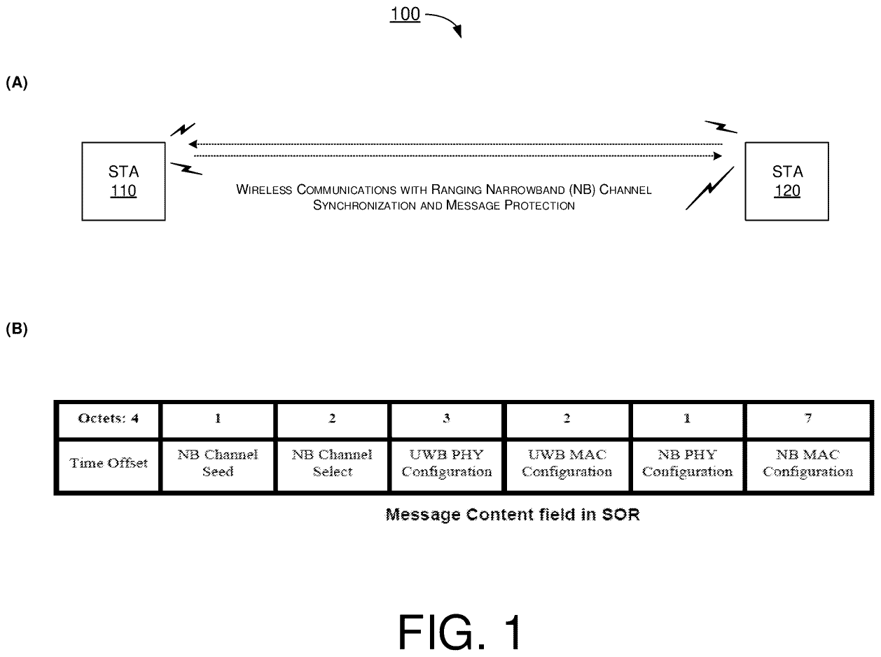

FIG. 1 illustrates an example network environment 100 in which various solutions and schemes in accordance with the present disclosure may be implemented. FIG. 1-FIG. 7 illustrate examples of implementation of various proposed schemes in network environment 100 in accordance with the present disclosure. The following description of various proposed schemes is provided with reference to FIG. 1-FIG. 7.

Referring to part (A) of FIG. 1, network environment 100 may include at least a first STA (STA 110) and a second STA (STA 120). Either STA 110 or STA 120 may be an initiator/controller STA (herein interchangeably referred to as “Initiator”), and either STA 110 or STA 120 may be a responder/controlee STA (herein interchangeably referred to as “Responder”). While there may be additional STAs involved in network environment 100 under one or more schemes proposed herein, for simplicity only two STAs (STA 110 and STA 120) are shown in FIG. 1 with the understanding that additional STAs may be involved (e.g., additional non-AP STAs participating in ranging sessions under the proposed schemes). Each of STA 110 and STA 120 may be configured to implement various proposed schemes in accordance with the present disclosure as described below. For instance, one of STA 110 and STA 120 may function as an initiator and the other of STA 110 and STA 120 may function as a responder in an NB ranging session under the proposed schemes. It is noteworthy that, while the various proposed schemes may be individually or separately described below, in actual implementations some or all of the proposed schemes may be utilized or otherwise implemented jointly. Of course, each of the proposed schemes may be utilized or otherwise implemented individually or separately.

Part (B) of FIG. 1 shows an example of the message content fields of a start-of-ranging (SOR) message. Referring to part (B) of FIG. 1, an SOR message may include a Time Offset field, an NB Channel Seed field, an NB Channel Select field, an UWB PHY Configuration field, an UWB MAC Configuration field, an NB PHY Configuration field, and an NB MAC Configuration field.

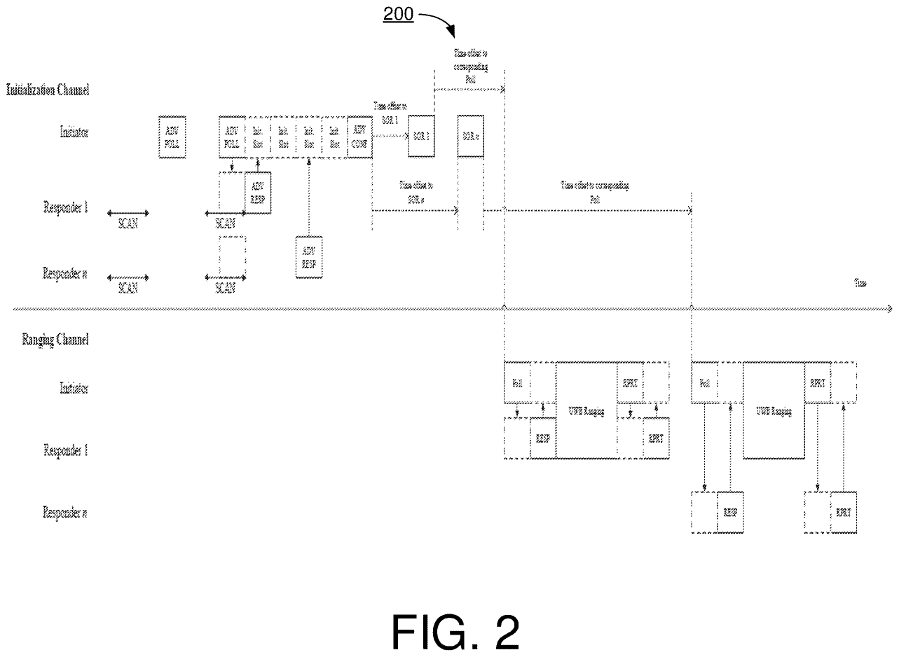

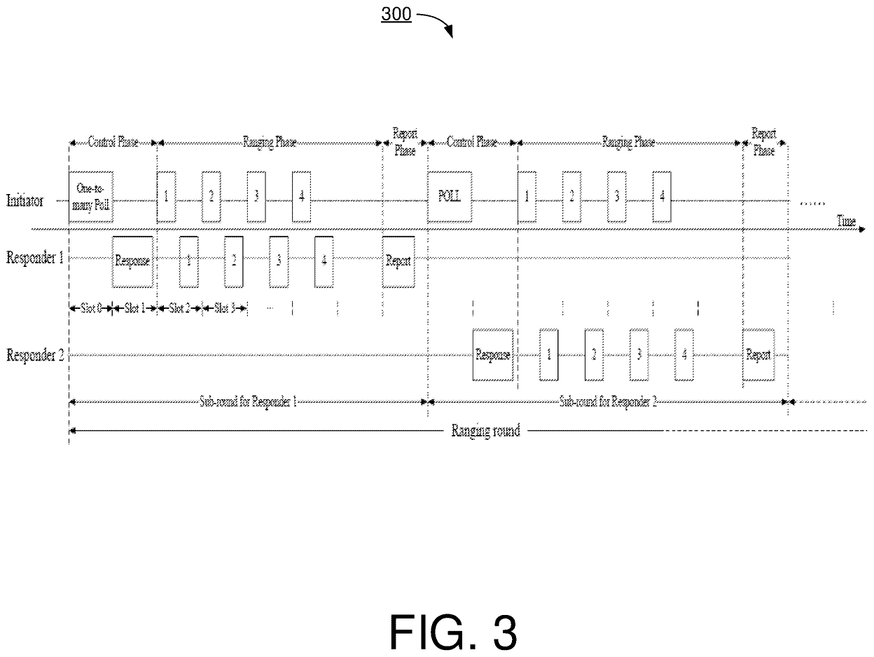

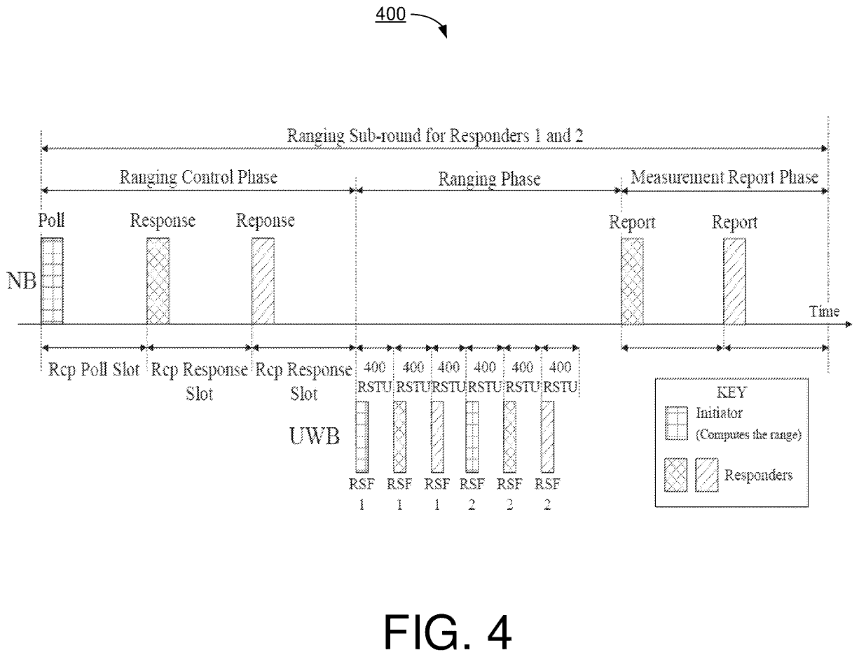

FIG. 2 illustrates an example scenario 200 in which various proposed schemes in accordance with the present disclosure may be implemented. Scenario 200 may pertain to a one-to-many ranging session initialization with responders joining in the same round. FIG. 3 illustrates an example scenario 300 in which various proposed schemes in accordance with the present disclosure may be implemented. Scenario 300 may pertain to a default one-to-many ranging scenario. FIG. 4 illustrates an example scenario 400 in which various proposed schemes in accordance with the present disclosure may be implemented. Scenario 400 may pertain to a time-efficient one-to-many ranging scenario.

Under a proposed scheme in accordance with the present disclosure, an SOR message, either for a one-to-many ranging session or a one-to-one ranging session, may provide either the NB ranging channel explicitly or a RangingBlockIndex to which the Time Offset field points. The explicit NB ranging channel information and/or RangingBlockIndex may facilitate a responder to find the hopping NB ranging channel of the first block of the responder after initialization, and the hopping NB ranging channel may be common to other responders currently on their second or third block in an ongoing one-to-many ranging session. Additionally, the RangingBlockIndex information in SOR may facilitate multiple responders to synchronize their V value used to generate the common RIFs transmitted by the initiator, if RIFs are enabled. Responders joining at different blocks may use different RangingBlockIndex information in their respective SOR message to initialized their V value to the same value at the same ranging block. Moreover, the RangingBlockIndex information in SOR for one-to-one ranging may facilitate the synchronization of the initiator and responder's V value if there is a previous initialization failure causing the reuse of the same V value. For example, in the previous initialization attempt, a O2O Response message may not be received by the initiator, even though the Response message, ranging sequence fragments (RSFs)/RIFs may have been transmitted by the responder. Upon re-initialization without a UWB session key exchange, the same V value is reused by the responder to generate RIF again.

Under another proposed scheme in accordance with the present disclosure, in case that the SOR message provides the NB ranging channel explicitly for the block to which the Time Offset field points, then the responder may verify that the initial NB channel is the same as the selected channel generated based on the channel seed and RangingBlockIndex provided by the initial Poll message. This may be equivalent to the SOR message providing the RangingBlockIndex of the responder's first block (pointed to by the Time Offset field). The responder may initialize V value for the RIFs based on the RangingBlockIndex provided by the Poll message. Advantageously, this may help responders joining at different blocks synchronize to the same counter value for the common RIFS sent by the initiator in time-efficient one-to-many ranging. Moreover, this may help the responder and the initiator in a one-to-one ranging to start from an unused V value if there is a previous initialization failure causing their counters to. For the rest of the document, we refer the V value as STS counter.

### Illustrative Implementations

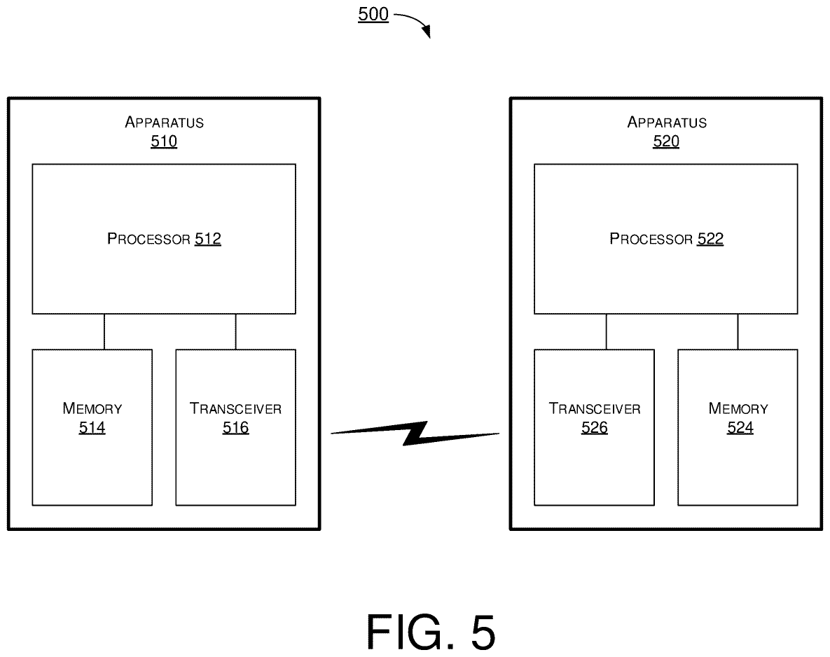

FIG. 5 illustrates an example system 500 having at least an example apparatus 510 and an example apparatus 520 in accordance with an implementation of the present disclosure. Each of apparatus 510 and apparatus 520 may perform various functions to implement schemes, techniques, processes and methods described herein pertaining to ranging NB channel synchronization in wireless communications, including the various schemes described above with respect to various proposed designs, concepts, schemes, systems and methods described above as well as processes described below. For instance, apparatus 510 may be implemented in STA 110 and apparatus 520 may be implemented in STA 120, or vice versa.

Each of apparatus 510 and apparatus 520 may be a part of an electronic apparatus, such as a portable or mobile apparatus, a wearable apparatus, a wireless communication apparatus or a computing apparatus. When implemented in a STA, each of apparatus 510 and apparatus 520 may be implemented in a smartphone, a smart watch, a personal digital assistant, a digital camera, or a computing equipment such as a tablet computer, a laptop computer or a notebook computer. Each of apparatus 510 and apparatus 520 may also be a part of a machine type apparatus, which may be an IoT apparatus such as an immobile or a stationary apparatus, a home apparatus, a wire communication apparatus or a computing apparatus. For instance, each of apparatus 510 and apparatus 520 may be implemented in a smart thermostat, a smart fridge, a smart door lock, a wireless speaker or a home control center. When implemented in or as a network apparatus, apparatus 510 and/or apparatus 520 may be implemented in a network node, such as an AP in a WLAN.

In some implementations, each of apparatus 510 and apparatus 520 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. In the various schemes described above, each of apparatus 510 and apparatus 520 may be implemented in or as a controller/initiator or a controlee/responder. Each of apparatus 510 and apparatus 520 may include at least some of those components shown in FIG. 5 such as a processor 512 and a processor 522, respectively, for example. Each of apparatus 510 and apparatus 520 may further include one or more other components not pertinent to the proposed scheme of the present disclosure (e.g., internal power supply, display device and/or user interface device), and, thus, such component(s) of apparatus 510 and apparatus 520 are neither shown in FIG. 5 nor described below in the interest of simplicity and brevity.

In one aspect, each of processor 512 and processor 522 may be implemented in the form of one or more single-core processors, one or more multi-core processors, one or more RISC processors or one or more CISC processors. That is, even though a singular term “a processor” is used herein to refer to processor 512 and processor 522, each of processor 512 and processor 522 may include multiple processors in some implementations and a single processor in other implementations in accordance with the present disclosure. In another aspect, each of processor 512 and processor 522 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 512 and processor 522 is a special-purpose machine specifically designed, arranged and configured to perform specific tasks including those pertaining to ranging NB channel synchronization in wireless communications in accordance with various implementations of the present disclosure.

In some implementations, apparatus 510 may also include a transceiver 516 coupled to processor 512. Transceiver 516 may include a transmitter capable of wirelessly transmitting and a receiver capable of wirelessly receiving data. In some implementations, apparatus 520 may also include a transceiver 526 coupled to processor 522. Transceiver 526 may include a transmitter capable of wirelessly transmitting and a receiver capable of wirelessly receiving data. It is noteworthy that, although transceiver 516 and transceiver 526 are illustrated as being external to and separate from processor 512 and processor 522, respectively, in some implementations, transceiver 516 may be an integral part of processor 512 as a system on chip (SoC) and/or transceiver 526 may be an integral part of processor 522 as a SoC.

In some implementations, apparatus 510 may further include a memory 514 coupled to processor 512 and capable of being accessed by processor 512 and storing data therein. In some implementations, apparatus 520 may further include a memory 524 coupled to processor 522 and capable of being accessed by processor 522 and storing data therein. Each of memory 514 and memory 524 may include a type of random-access memory (RAM) such as dynamic RAM (DRAM), static RAM (SRAM), thyristor RAM (T-RAM) and/or zero-capacitor RAM (Z-RAM). Alternatively, or additionally, each of memory 514 and memory 524 may include a type of read-only memory (ROM) such as mask ROM, programmable ROM (PROM), erasable programmable ROM (EPROM) and/or electrically erasable programmable ROM (EEPROM). Alternatively, or additionally, each of memory 514 and memory 524 may include a type of non-volatile random-access memory (NVRAM) such as flash memory, solid-state memory, ferroelectric RAM (FeRAM), magnetoresistive RAM (MRAM) and/or phase-change memory.

Each of apparatus 510 and apparatus 520 may be a communication entity capable of communicating with each other using various proposed schemes in accordance with the present disclosure. For illustrative purposes and without limitation, a description of capabilities of apparatus 510 or apparatus 520, as STA 110 and STA 120, respectively, is provided below in the context of example processes 600 and 700. It is noteworthy that, although a detailed description of capabilities, functionalities and/or technical features of either of apparatus 510 and apparatus 520 is provided below, the same may be applied to the other of apparatus 510 and apparatus 520 although a detailed description thereof is not provided solely in the interest of brevity. It is also noteworthy that, although the example implementations described below are provided in the context of WLAN, the same may be implemented in other types of networks.

### Illustrative Processes

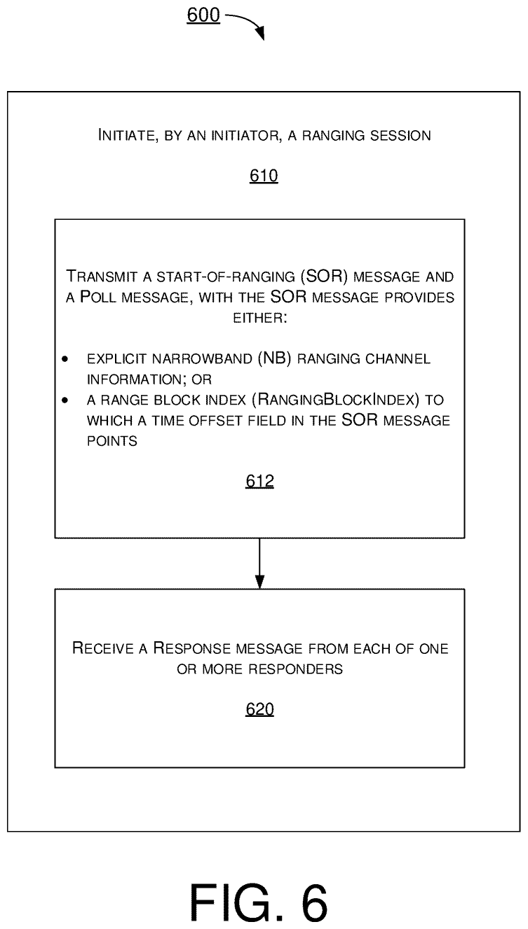

FIG. 6 illustrates an example process 600 in accordance with an implementation of the present disclosure. Process 600 may represent an aspect of implementing various proposed designs, concepts, schemes, systems, and methods described above. More specifically, process 600 may represent an aspect of the proposed concepts and schemes pertaining to ranging NB channel synchronization in wireless communications. Process 600 may include one or more operations, actions, or functions as illustrated by one or more of blocks/subblocks. Although illustrated as discrete blocks, various blocks of process 600 may be divided into additional blocks, combined into fewer blocks, or eliminated, depending on the desired implementation. Moreover, the blocks/sub-blocks of process 600 may be executed in the order shown in FIG. 6 or, alternatively, in a different order. Furthermore, one or more of the blocks/sub-blocks of process 600 may be executed repeatedly or iteratively. Process 600 may be implemented by or in apparatus 510 and apparatus 520 as well as any variations thereof. Solely for illustrative purposes and without limiting the scope, process 600 is described below in the context of apparatus 510 and implemented in or as a ranging controlee/responder (e.g., a wireless communication device) and apparatus 520 implemented in or as ranging controller/initiator of a wireless network in network environment 100, or vice vera, in accordance with one or more of IEEE 802.15.4 standards. Process 600 may begin at block 610.

At 610, process 600 may include processor 512 of apparatus 510 initiating, via transceiver 516, a ranging session by performing operations represented by 612 and 614.

At 612, process 600 may involve processor 512 transmitting, via transceiver 516, an SOR message and a Poll message. The SOR message may provide either: (a) explicit NB ranging channel information; or (b) a RangingBlockIndex to which a time offset field in the SOR message points. Process 600 may proceed from 612 to 614.

At 614, process 600 may involve processor 512 receiving, via transceiver 516, a Response message from each of one or more responders.

In some implementations, each of the explicit NB ranging channel information and the ranging block index may facilitate each of the one or more responders to find a hopping NB ranging channel of a first block of the respective responder after initialization.

In some implementations, the hopping NB ranging channel may be common to at least one other responder of the one or more responders currently on a subsequent block in an ongoing one-to-many ranging session.

In some implementations, RangingBlockIndex information in the SOR message may facilitate multiple responders of the one or more responders to synchronize an STS counter of common RIFs transmitted by the initiator.

In some implementations, RangingBlockIndex information in the SOR message for one-to-one ranging may facilitate synchronization of the initiator and an STS counter of a responder of the one or more responders in an event that there is a previous initialization failure causing STS counters to be reused after re-initialization.

In some implementations, the explicit NB ranging channel information may indicate an NB ranging channel for a block to which the time offset field points so that each responder of the one or more responders is able to verify that an initial NB channel is same as a selected channel generated based on a channel seed and another ranging block index provided by the Poll message.

Alternatively, or additionally, the explicit NB ranging channel information may indicate a ranging block index for a block to which the time offset field points so that each responder of the one or more responders is able to initialize a respective STS counter for RIFs based on the ranging block index.

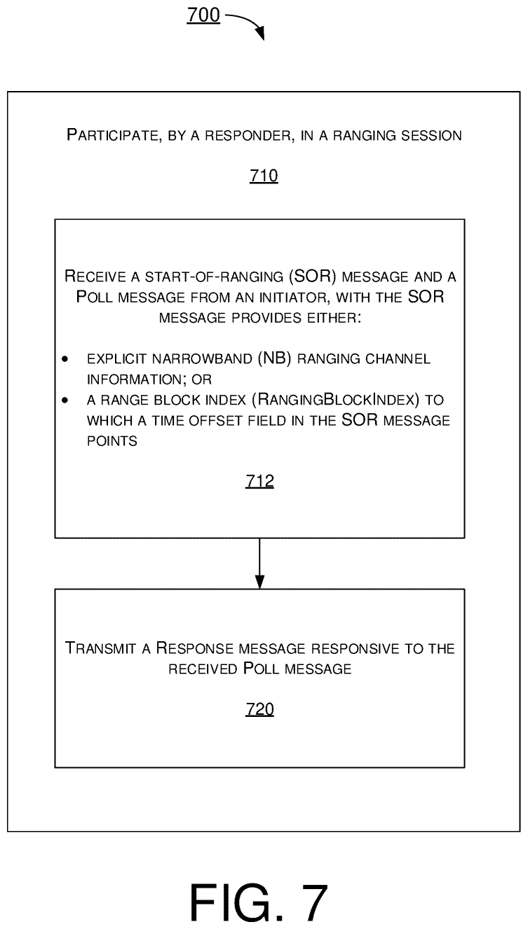

FIG. 7 illustrates an example process 700 in accordance with an implementation of the present disclosure. Process 700 may represent an aspect of implementing various proposed designs, concepts, schemes, systems, and methods described above. More specifically, process 700 may represent an aspect of the proposed concepts and schemes pertaining to ranging NB channel synchronization in wireless communications. Process 700 may include one or more operations, actions, or functions as illustrated by one or more of blocks/subblocks. Although illustrated as discrete blocks, various blocks of process 700 may be divided into additional blocks, combined into fewer blocks, or eliminated, depending on the desired implementation. Moreover, the blocks/sub-blocks of process 700 may be executed in the order shown in FIG. 7 or, alternatively, in a different order. Furthermore, one or more of the blocks/sub-blocks of process 700 may be executed repeatedly or iteratively. Process 700 may be implemented by or in apparatus 510 and apparatus 520 as well as any variations thereof. Solely for illustrative purposes and without limiting the scope, process 700 is described below in the context of apparatus 510 and implemented in or as a ranging controlee/responder (e.g., a wireless communication device) and apparatus 520 implemented in or as ranging controller/initiator of a wireless network in network environment 100, or vice vera, in accordance with one or more of IEEE 802.15.4 standards. Process 700 may begin at block 710.

At 710, process 700 may include processor 522 of apparatus 520 participating, via transceiver 526, a ranging session by performing operations represented by 712 and 714.

At 712, process 600 may involve processor 522 receiving, via transceiver 526, an SOR message and a Poll message from an initiator. The SOR message may provide either: (a) explicit NB ranging channel information; or (b) a RangingBlockIndex to which a time offset field in the SOR message points. Process 700 may proceed from 712 to 714.

At 714, process 700 may involve processor 522 transmitting, via transceiver 526, a Response message responsive to the received Poll message.

In some implementations, each of the explicit NB ranging channel information and the ranging block index may facilitate the responder to find a hopping NB ranging channel of a first block of the responder after initialization.

In some implementations, the hopping NB ranging channel may be common to at least one other responder currently on a subsequent block in an ongoing one-to-many ranging session.

In some implementations, RangingBlockIndex information in the SOR message may facilitate multiple responders, including apparatus 520, to synchronize an STS counter of common RIFs transmitted by the initiator.

In some implementations, RangingBlockIndex information in the SOR message for one-to-one ranging may facilitate synchronization of the initiator and an STS counter of the responder in an event that there is a previous initialization failure causing STS counters to be reused after re-initialization.

In some implementations, responsive to the explicit NB ranging channel information indicating an NB ranging channel for a block to which the time offset field points, process 700 may further involve processor 522 verifying that an initial NB channel is same as a selected channel generated based on a channel seed and another ranging block index provided by the Poll message.

Alternatively, or additionally, responsive to the explicit NB ranging channel information indicating a ranging block index for a block to which the time offset field points, process 700 may further involve processor 522 initializing an STS counter for RIFs based on the ranging block index.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
initiating, by an initiator, a ranging session by:
transmitting a start-of-ranging (SOR) message and a Poll message; and
receiving a Response message from each of one or more responders,
wherein the SOR message provides either:
explicit narrowband (NB) ranging channel information; or
a range block index (RangingBlockIndex) to which a time offset field in the SOR message points.

2. The method of claim 1, wherein each of the explicit NB ranging channel information and the ranging block index facilitates each of the one or more responders to find a hopping NB ranging channel of a first block of the respective responder after initialization.

3. The method of claim 2, wherein the hopping NB ranging channel is common to at least one other responder of the one or more responders currently on a subsequent block in an ongoing one-to-many ranging session.

4. The method of claim 1, wherein RangingBlockIndex information in the SOR message facilitates multiple responders of the one or more responders to synchronize a scrambled timestamp sequence (STS) counter of common ranging integrity fragments (RIFs) transmitted by the initiator.

5. The method of claim 1, wherein RangingBlockIndex information in the SOR message for one-to-one ranging facilitates synchronization of the initiator and a scrambled timestamp sequence (STS) counter of a responder of the one or more responders in an event that there is a previous initialization failure causing STS counters to be reused after re-initialization.

6. The method of claim 1, wherein the explicit NB ranging channel information indicates an NB ranging channel for a block to which the time offset field points so that each responder of the one or more responders is able to verify that an initial NB channel is same as a selected channel generated based on a channel seed and another ranging block index provided by the Poll message.

7. The method of claim 1, wherein the explicit NB ranging channel information indicates a ranging block index for a block to which the time offset field points so that each responder of the one or more responders is able to initialize a respective scrambled timestamp sequence (STS) counter for ranging integrity fragments (RIFs) based on the ranging block index.

8. A method, comprising:
participating, by a responder, in a ranging session by:
receiving a start-of-ranging (SOR) message and a Poll message from an initiator; and
transmitting a Response message responsive to the received Poll message,
wherein the SOR message provides either:
explicit narrowband (NB) ranging channel information; or
a range block index (RangingBlockIndex) to which a time offset field in the SOR message points.

9. The method of claim 8, wherein each of the explicit NB ranging channel information and the ranging block index facilitates the responder to find a hopping NB ranging channel of a first block of the responder after initialization.

10. The method of claim 9, wherein the hopping NB ranging channel is common to at least one other responder currently on a subsequent block in an ongoing one-to-many ranging session.

11. The method of claim 8, wherein RangingBlockIndex information in the SOR message facilitates multiple responders, including the responder, to synchronize a scrambled timestamp sequence (STS) counter of common ranging integrity fragments (RIFs) transmitted by the initiator.

12. The method of claim 8, wherein RangingBlockIndex information in the SOR message for one-to-one ranging facilitates synchronization of the initiator and a scrambled timestamp sequence (STS) counter of the responder in an event that there is a previous initialization failure causing STS counters to be reused after re-initialization.

13. The method of claim 8, responsive to the explicit NB ranging channel information indicating an NB ranging channel for a block to which the time offset field points, further comprising:
verifying that an initial NB channel is same as a selected channel generated based on a channel seed and another ranging block index provided by the Poll message.

14. The method of claim 8, responsive to the explicit NB ranging channel information indicating a ranging block index for a block to which the time offset field points, further comprising:
initializing a scrambled timestamp sequence (STS) counter for ranging integrity fragments (RIFs) based on the ranging block index.

15. An apparatus implementable in a responder, comprising:
a transceiver configured to communicate wirelessly; and
a processor coupled to the transceiver and configured to perform operations comprising:
participating, via the transceiver, in a ranging session by:
receiving a start-of-ranging (SOR) message and a Poll message from an initiator; and
transmitting a Response message responsive to the received Poll message, wherein the SOR message provides either:
explicit narrowband (NB) ranging channel information; or
a range block index (RangingBlockIndex) to which a time offset field in the SOR message points.

16. The apparatus of claim 15, wherein each of the explicit NB ranging channel information and the ranging block index facilitates the responder to find a hopping NB ranging channel of a first block of the responder after initialization.

17. The apparatus of claim 16, wherein the hopping NB ranging channel is common to at least one other responder currently on a subsequent block in an ongoing one-to-many ranging session.

18. The apparatus of claim 15, wherein RangingBlockIndex information in the SOR message facilitates multiple responders, including the responder, to synchronize a scrambled timestamp sequence (STS) counter of common ranging integrity fragments (RIFs) transmitted by the initiator.

19. The apparatus of claim 15, wherein RangingBlockIndex information in the SOR message for one-to-one ranging facilitates synchronization of the initiator and a scrambled timestamp sequence (STS) counter of the responder in an event that there is a previous initialization failure causing STS counters to be reused after reinitialization.

20. The apparatus of claim 15, responsive to the explicit NB ranging channel information indicating an NB ranging channel for a block to which the time offset field points, the processor is further configured to perform operations comprising:
verifying that an initial NB channel is same as a selected channel generated based on a channel seed and a ranging block index provided by the Poll message; or
initializing a scrambled timestamp sequence (STS) counter for ranging integrity fragments (RIFs) based on the ranging block index provided by the SOR message.
